(19) United States
(12) Patent Application Publication
(10) Pub. No.: US 2023/0007281 A1
(43) Pub. Date: Jan. 5, 2023

(54) Video Encoding or Decoding Methods and Apparatuses with Scaling Ratio Constraint

(71) Applicant: HFI Innovation Inc., Zhubei City, Hsinchu County (TW)

(72) Inventors: Tzu-Der CHUANG, Hsinchu City (TW); Chih-Wei HSU, Hsinchu City (TW); Ching-Yeh CHEN, Hsinchu City (TW); Chia-Ming TSAI, Hsinchu City (TW); Chun-Chia CHEN, Hsinchu City (TW); Olena CHUBACH, San Jose, CA (US); Lulin CHEN, San Jose, CA (US); Yu-Wen HUANG, Hsinchu City (TW)

(21) Appl. No.: 17/781,497

(22) PCT Filed: Dec. 10, 2020
(86) PCT No.: PCT/CN2020/135301

§ 371 Date: Jun. 1, 2022

Related U.S. Application Data
(60) Provisional application No. 62/949,506, filed on Dec. 18, 2019.
(60) Provisional application No. 62/946,540, filed on Dec. 11, 2019.

(51) Int. Cl. H04N 19/196; H04N 19/139; H04N 19/105; H04N 19/132; H04N 19/176; H04N 19/52

(52) U.S. Cl. CPC H04N 19/196; H04N 19/139; H04N 19/105; H04N 19/132; H04N 19/176; H04N 19/52

(57) ABSTRACT

Video processing methods and apparatuses for processing a current block in a current picture by reference picture resampling include receiving input data of the current block, determining a scaling window of the current picture and a scaling window of a reference picture. The current picture and reference picture may have different scaling window sizes. A ratio between a scaling window width, height, or size of the current picture and a scaling window width, height, or size of the reference picture is constrained to be within a ratio constraint. A reference block is generated from the reference picture according to the ratio, and used to encode or decode the current block.

### CROSS REFERENCE TO RELATED APPLICATION

The present invention claims priority to U.S. Provisional Patent Application, Ser. No. 62/946,540, filed on Dec. 11, 2019, entitled “Method of Scaling Ratio Constraint”, and U.S. Provisional Patent Application, Ser. No. 62/949,506, filed on Dec. 18, 2019, entitled “Method of Scaling Window Constraint”. The U.S. Provisional Patent Applications are hereby incorporated by reference in their entireties.

### FIELD OF THE INVENTION

The present invention relates to video processing methods and apparatuses in video encoding and decoding systems. In particular, the present invention relates to scaling ratio constraint for reference picture resampling.

### BACKGROUND AND RELATED ART

The Versatile Video Coding (VVC) standard is the upcoming emerging video coding standard which has been developed incrementally based on the former High Efficiency Video Coding (HEVC) standard by enhancing existing coding tools and introducing multiple new coding tools in various building blocks of the codec structure. The VVC standard improves compression performance and efficiency of transmission and storage, and supports new formats such as the High Dynamic Range and omni-directional 360 video. The VVC standard makes video transmission in mobile networks more efficiently as it allows systems or locations with poor data rates to receive larger files more quickly. VVC supports layer coding, spatial or Signal to Noise Ratio (SNR) temporal scalability.

Reference Picture Resampling (RPR) In the VVC standard, fast representation switching for adaptive streaming services is desired to deliver multiple representations of the same video content at the same time, each having different properties. Different properties involve with different spatial resolutions or different sample bit depths. In real-time video communications, by allowing resolution changes within a coded video sequence without inserting an I-picture, not only the video data can be adapted to dynamic channel conditions and user preference seamlessly, but the beating effect caused by the I-pictures can also be removed. Reference Picture Resampling (RPR) allows pictures with different resolutions can reference each other in inter prediction. FIG. 1 illustrates an example of applying reference picture resampling to encode or decode a current picture, where inter coded blocks of the current picture are predicted from reference pictures with same or different sizes. Spatial scalability is beneficial in streaming applications. The picture size of the reference picture can be different from the current picture when spatial scalability is supported. RPR is adopted in the VVC standard to support the on-the-fly upsampling and downsampling motion compensation.

Table 1 shows an example of signaling an RPR enabling flag and a maximum picture size in a Sequence Parameter Set (SPS). A RPR enabling flag sps_ref_pic_resampling_enabled_flag signaled in a Sequence Parameter Set (SPS) is used to indicate whether RPR is enabled for pictures referring to the SPS. When this RPR enabling flag is equal to 1, a current picture referring to the SPS may have slices that refer to a reference picture in an active entry of a reference picture layer that has one or more of the following seven parameters different than that of the current picture. The seven parameters include syntax elements associated with a picture width pps_pic_width_in_luma_samples, a picture height pps_pic_height_in_luma_samples, a left scaling window offset pps_scaling_win_left_offset, a right scaling window offset pps_scaling_win_right_offset, a top scaling window offset pps_scaling_win_top_offset, a bottom scaling window offset pps_scaling_win_bottom_offset, and a number of sub-pictures sps_num_subpics_minus1. For a current picture referring to a reference picture that has one or more of these seven parameters different than that of the current picture, the reference picture could either belong to the same layer or a different layer than the layer containing the current picture. The syntax element sps_res_change_in_clvs_allowed_flag equals to 1 specifying that the picture spatial resolution might change within a Coded Layer Video Sequence (CLVS) referring to the SPS, and this syntax element equals to 0 specifying that the picture spatial resolution does not change within any CLVS referring to the SPS. When this syntax element sps_res_change_in_clvs_allowed_flag is not present in the SPS, the value is inferred to be equal to 0. The maximum picture size is signaled in the SPS by syntax elements sps_pic_width_max_in_luma_samples and sps_pic_height_max_in_luma_samples, and the maximum picture size shall not be larger than the Output Layer Set (OLS) Decoded Picture Buffer (DPB) picture size signaled in the corresponding Video Parameter Set (VPS).

TABLE 1

| | Descriptor |
|---|---|
| seq_parameter_set_rbsp( ) { | |
| ... | |
| sps_ref_pic_resampling_enabled_flag | u(1) |
| if (sps_ref_pic_resampling_enabled_flag) | |
| sps_res_change_in_clvs_allowed_flag | u(1) |
| sps_pic_width_max_in_luma_samples | ue(v) |
| Sps_pic_height_max_in_luma_samples | ue(v) |

When predicting a current picture using RPR, a picture size ratio is derived from the reference picture width or height and the current picture width or height. The picture size ratio is constrained to be within a range between ⅛ and 2. For example, the picture width and height measured in luma samples are derived by syntax elements pic_width_in_luma_samples and pic_height_in_luma_samples signaled in a Picture Parameter Set (PPS). The syntax element pic_width_in_luma_samples specifies the width of each decoded picture referring to the PPS in units of luma samples. This syntax element shall not be equal to 0 and shall be an integer multiple of Max(8, MinCbSizeY), and is constrained to be less than or equal to pic_width_max_in_luma_samples. The value of this syntax element pic_width_in_luma_samples shall be equal to pic_width_max_in_luma_samples when a sub-picture present flag subpics_present_flag is equal to 1 or when the RPR enabling flag ref_pic_resampling_enabled_flag is equal to 0. The syntax element pic_height_in_luma_samples specifies the height of each decoded picture referring to the PPS in units of luma samples. This syntax element shall not be equal to 0 and shall be an integer multiple of Max(8, MinCbSizeY), and shall be less than or equal to pic_height_max_in_luma_samples. The value of the syntax element pic_height_in_luma_samples is set to be equal to pic_height_max_in_luma_samples when the sub-picture present flag subpics_present_flag is equal to 1 or when the RPR enabling flag ref_pic_resampling_enabled_flag is equal to 0.

In the current design of RPR in VVC draft 6, when the picture size of a current picture and reference pictures are specified, the following constraint has to be satisfied. This constraint limits the picture size ratio between the reference picture and the current picture to be within the range of [⅛, 2]. Let variables refPicWidthInLumaSamples and refPicHeightInLumaSamples be the picture width and picture height of a reference picture referenced by a current picture. It is a requirement of bitstream conformance that all of the following conditions are satisfied: the picture width of the current picture pic_width_in_luma_samples multiplied by 2 shall be greater than or equal to the picture width of the reference picture refPicWidthInLumaSamples, the picture height of the current picture pic_height_in_luma_samples multiplied by 2 shall be greater than or equal to the picture height of the reference picture refPicHeightInLumaSamples, the picture width of the current picture pic_width_in_luma_samples shall be less than or equal to the picture width of the reference picture refPicWidthInLumaSample multiplied by 8, and the picture height of the current picture pic_height_in_luma_samples shall be less than or equal to the picture height of the reference picture refPicHeightInLumaSamples multiplied by 8.

The picture size scaling ratio between a reference picture and a current picture is derived from syntax elements pic_width_in_luma_samples and pic_height_in_luma_samples signaled in a PPS associated with the reference picture and syntax elements pic_width_in_luma_samples and pic_height_in_luma_samples signaled in a PPS associated with the current picture. The scaling window offsets for RPR are also derived from syntax elements signaled in the PPS. These syntax elements signaled in the PPS and corresponding semantic are shown in Table 2.

TABLE 2

| | Descriptor |
|---|---|
| pic_parameter_set_rbsp( ) { | |
| pps_pic_parameter_set_id | ue(v) |
| pps_seq_parameter_set_id | u(4) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| scaling_window_flag | u(1) |
| if( scaling_window_flag ) { | |
| scaling_win_left_offset | ue(v) |
| scaling_win_right_offset | ue(v) |
| scaling_win_top_offset | ue(v) |
| scaling_win_bottom_offset | ue(v) |
| } | |
| ... | |

The syntax element scaling_window_flag equals to 1 specifying scaling window offset parameters are present in the PPS, and scaling_window_flag equals to 0 specifying scaling window offset parameters are not present in the PPS. The value of this syntax element scaling_window_flag shall be equal to 0 when a RPR enabling flag ref_pic_resampling_enabled_flag is equal to 0. The syntax elements scaling_win_left_offset, scaling_win_right_offset, scaling_win_top_offset, and scaling_win_bottom_offset specify the scaling offsets in units of luma samples. These scaling offsets are applied to the picture size for scaling ratio calculation. The scaling offsets can be negative values. The values of these four scaling offset syntax elements, scaling_win_left_offset, scaling_win_right_offset, scaling_win_top_offset, and scaling_win_bottom_offset are inferred to be equal to 0 when a scaling window flag scaling_window_flag is equal to 0.

The value of a sum of the left and right offsets scaling_win_left_offset and scaling_win_right_offset shall be less than the picture width pic_width_in_luma_samples, and the value of a sum of the top and bottom offsets scaling_win_top_offset and scaling_win_bottom_offset shall be less than the picture height pic_height_in_luma_samples. The variable PicOutputWidthL representing a scaling window width is derived by subtracting the right and left offsets from the picture width. PicOutputWidthL=pic_width_in_luma_samples−(scaling_win_right_offset+scaling_win_left_offset). The variable PicOutputHeightL representing a scaling window height is derived by subtracting the top and bottom offsets from the picture height. PicOutputHeightL=pic_height_in_luma_samples−(scaling_win_bottom_offset+scaling_win_top_offset).

A variable fRefWidth is set equal to PicOutputWidthL of a reference picture RefPicList[i][j] in luma samples, and a variable fRefHight is set equal to PicOutputHeightL of the reference picture RefPicList[i][j] in luma samples. A derived reference picture scaling ratio for the horizontal direction RefPicScale[i][j][0] is calculated by ((fRefWidth<<14)+(PicOutputWidthL>>1))/PicOutputWidthL, and a derived reference picture scaling ratio for the vertical direction RefPicScale[i][j][1] is calculated by ((fRefHeight<<14)+(PicOutputHeightL>>1))/PicOutputHeightL. The derived reference picture scaling ratio is thus RefPicIsScaled[i][j]=(RefPicScale [i][j][0]!=(1<<14))∥(RefPicScale[i][j][1]!=(1<<14).

In a more recent proposal of the VVC standard, the scaling window offsets are measured in chroma samples, and when these scaling window offset syntax elements are not present in the PPS, the values of these four scaling offset syntax elements scaling_win_left_offset, scaling_win_right_offset, scaling_win_top_offset, and scaling_win_bottom_offset are inferred to be equal to conf_win_left_offset, conf_win_right_offset, conf_win_top_offset, and conf_win_bottom_offset, respectively. A variable CurrPicScalWinWidthL indicating the scaling window width is derived by the picture width, SubWidthC, left scaling offset, and right scaling offset, and a variable CurrPicScalWinHeightL indicating the scaling window height is derived by the picture height, SubHeightC, top scaling offset, and bottom scaling offset as shown in the following. CurrPicScalWinWidthL=pic_width_in_luma_samples−SubWidthC*(scaling_win_right_offset+scaling_win_left_offset); and CurrPicScalWinHeightL=pic_height_in_luma_samples−SubHeightC*(scaling_win_bottom_offset+scaling_win_top_offset).

### BRIEF SUMMARY OF THE INVENTION

In exemplary embodiments of the video processing method for processing a current block in a current picture, a video encoding or decoding system implementing the video processing method receives input video data associated with the current block, determines a scaling window width, height, or size of the current picture, determines a scaling window width, height, or size of a reference picture, generates a reference block by a ratio between the scaling window width, height, or size of the current picture and the scaling window width, height, or size of the reference picture, performs motion compensation for the current block using the reference block, and encodes or decodes the current block in the current picture. The ratio between the scaling window width, height, or size of the current picture and the scaling window width, height, or size of the reference picture is constrained within a ratio constraint.

In some exemplary embodiments, the ratio constraint is between 1/M and N, where M and N are positive integers. For the ratio between the scaling window width of the current picture and the scaling window width of the reference block to be within the ratio constraint, N times the scaling window width of the current picture is greater than or equal to the scaling window width of the reference picture, and the scaling window width of the current picture is less than or equal to M times the scaling window width of the reference picture. For the ratio between the scaling window height of the current picture and the scaling window height of the reference picture to be within the ratio constraint, N times the scaling window height of the current picture is greater than or equal to the scaling window height of the reference picture, and the scaling window height of the current picture is less than or equal to M times the scaling window height of the reference picture. In one embodiment, the scaling window size includes both the scaling window width and the scaling window height. For the ratio between the scaling window size of the current picture and the scaling window size of the reference picture to be within the ratio constraint, N times the scaling window width of the current picture is greater than or equal to the scaling window width of the reference picture, N times the scaling window height of the current picture is greater than or equal to the scaling window height of the reference picture, the scaling window width of the current picture is less than or equal to M times the scaling window width of the reference picture, and the scaling window height of the current picture is less than or equal to M times the scaling window height of the reference picture For example, the ratio constraint is between ⅛ and 2. In cases when the scaling window size of the current picture is smaller than the scaling window size of the reference picture, 2 times the scaling window width of the current picture is greater than or equal to the scaling window with of the reference picture, and 2 times the scaling window height of the current picture is greater than or equal to the scaling window height of the reference picture. In cases when the scaling window size of the current picture is larger than the scaling window size of the reference picture, the scaling window width of the current picture is less than or equal to 8 times the scaling window width of the reference picture, and the scaling window height of the current picture is less than or equal to 8 times the scaling window height of the reference picture.

In some embodiments, the scaling window width of the current picture is derived by a picture width, a left scaling window offset, and a right scaling window offset of the current picture, and the scaling window height of the current picture is derived by a picture height, a top scaling window offset, and a bottom scaling window offset of the current picture. The picture width, left scaling window offset, right scaling window offset, picture height, top scaling window offset, and bottom scaling window offset of the current picture are signaled in a PPS associated with the current picture.

In an embodiment, the scaling window offsets are measured in luma samples, the scaling window width of the current picture is derived by subtracting the left scaling window offset and the right scaling window offset from the picture width of the current picture, and the scaling window height of the current picture is derived by subtracting the top scaling window offset and the bottom scaling window offset form the picture height of the current picture. In another embodiment, the scaling window offsets are measured in chroma samples, the scaling window width of the current picture is derived by the picture width, left and right scaling window offsets, and a variable SubWidthC, and the scaling window height of the current picture is derived by the picture height, top and bottom scaling window offsets, and a variable SubHeightC. These variables SubWidthC and SubHeightC indicate down-sampling ratios associated with chroma bitplanes in horizontal and vertical dimensions. The scaling window width of the current picture is derived by multiplying the variable SubWidthC with a sum of the left scaling window offset and the right scaling window offset and then subtracting from the picture width of the current picture. The scaling window height of the current picture is derived by multiplying the variable SubHeightC with a sum of the top scaling window offset and the bottom scaling window offset and then subtracting from the picture height of the current picture.

In an embodiment, a reference picture scaling ratio is derived for motion compensation from the scaling window width, height, or size of the current picture and the scaling window width, height, or size of the reference picture, and the reference picture scaling ratio is constrained to be within a range of [2048, 32768].

In an embodiment, for an encoder side to generate a bitstream corresponding to encoded data of a video sequence, or for a decoder side to receive a bitstream corresponding to encoded data of a video sequence, it is a bitstream conformance requirement that 2 times the scaling window width of the current picture is greater than or equal to the scaling window width of the reference picture, 2 times the scaling window height of the current picture is greater than or equal to the scaling window height of the reference picture, the scaling window width of the current picture is less than or equal to 8 times the scaling window width of the reference picture, and the scaling window height of the current picture is less than or equal to 8 times the scaling window height of the reference picture.

Aspects of the disclosure further provide an apparatus for video processing in a video encoding or decoding system, the apparatus comprising one or more electronic circuits configured for receiving input video data of a current block in a current picture, determining a scaling window width, height, or size of the current picture, determining a scaling window width, height, or size of a reference picture, generating a reference block from the reference picture, performing motion compensation for the current block using the reference block, and encoding or decoding the current block in the current picture. A ratio between the scaling window width, height, or size of the current picture and the scaling window width, height, or size of the reference picture is within a ratio constraint.

Aspects of the disclosure further provide a non-transitory computer readable medium storing program instructions for causing a processing circuit of an apparatus to perform a video processing method to encode or decode a current block in a current picture. The video processing method determines a scaling window width, height, or size of the current picture, determines a scaling window width, height, or size of a reference picture, generates a reference block from the reference picture, encodes or decodes the current block according to the reference block. A ratio between the scaling window width, height, or size of the current picture and the scaling window width, height, or size of the reference picture is constrained to be within a ratio constraint. Other aspects and features of the invention will become apparent to those with ordinary skill in the art upon review of the following descriptions of specific embodiments.

### BRIEF DESCRIPTION OF THE DRAWINGS

Various embodiments of this disclosure that are proposed as examples will be described in detail with reference to the following figures, and wherein:

FIG. 1 illustrates a hypothetical example of enabling reference picture resampling.

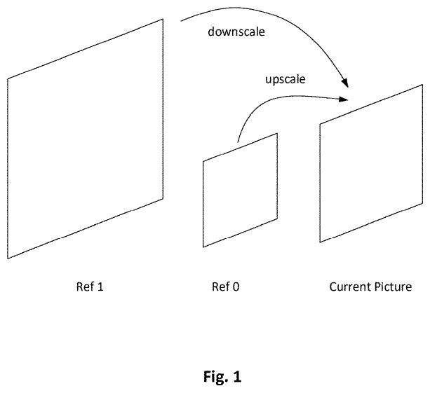

FIG. 2 demonstrates an example of enabling reference picture resampling considering the scaling window size of each picture.

FIG. 3 illustrates an exemplary flowchart of a video encoding or decoding system for checking a scaling window ratio between a current picture and a reference picture according to an embodiment of the present invention.

FIG. 4 is a flowchart showing an embodiment of a video processing method for encoding or decoding a current block by enabling reference picture resampling in a video encoding or decoding system.

FIG. 5 illustrates an exemplary system block diagram for a video encoding system incorporating the video processing method according to embodiments of the present invention.

FIG. 6 illustrates an exemplary system block diagram for a video decoding system incorporating the video processing method according to embodiments of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

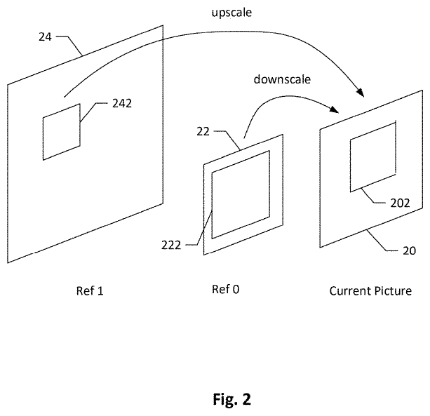

Constrain Reference Picture Scaling Ratio In VVC draft 6, one bitstream conformance requirement is applied to constrain a picture size ratio of a reference picture to a current picture to be within [⅛, 2]. The picture size ratio is derived from a reference picture width/height/size and a current picture width/height/size. The picture size ratio constraint is specified to be within [⅛, 2] as the interpolation filters only supports scaling ratios between ⅛ and 2. Some embodiments of the present invention apply the [⅛, 2] ratio constraint to a scaling ratio between a current scaling window width, height, or size and a reference scaling window width, height, or size. The scaling ratio is calculated by scaling window widths, heights, or sizes instead of picture widths, heights, or sizes. FIG. 2 illustrates an example of performing motion compensation by referencing two reference pictures with different picture sizes and difference scaling window sizes. A current picture 20 as shown in FIG. 2 has a scaling window 202, and although a first reference picture 22 is smaller than the current picture 20, a scaling window 222 of the first reference picture 22 is larger than the scaling window 202 of the current picture, which implies a scaling ratio of less than 1 is applied to downscale the scaling window 222 to be referenced by the current picture. A second reference picture 24 is larger than the current picture 20, however, a scaling window 242 of the second reference picture 24 is smaller than the scaling window 202 of the current picture, so a scaling ratio of larger than 1 is applied to upscale the scaling window 242 to be referenced by the current picture.

In one embodiment, a scaling window width of a current picture PicOutputWidthL is derived by a picture width pic_width_in_luma_samples, a left scaling window offset scaling_win_left_offset, and a right scaling window offset scaling_win_right_offset signaled in the PPS associated with the current picture, i.e. PicOutputWidthL=pic_width_in_luma_samples−(scaling_win_right_offset+scaling_win_left_offset), and a scaling window height of the current picture PicOutputHeightL is derived by a picture height pic_height_in_luma_samples, a top scaling window offset scaling_win_top_offset, and a bottom scaling window offset scaling_win_bottom_offset, i.e. PicOutputHeightL=pic_height_in_luma_samples−(scaling_win_bottom_offset+scaling_win_top_offset). When scaling_window_flag is equal to 1, let refPicOutputWidthL and refPicOutputHiehgtL be a scaling window width of a reference picture and a scaling window height of the reference picture respectively. A reference block in the reference picture is determined to be referenced by a current block of the current picture. For example, a video encoding system determines the reference block by motion estimation, and a video decoding system determines the reference block by parsing motion information of the current block signaled in the video bitstream. It is a requirement of the bitstream conformance that all of the following four conditions are satisfied when the ratio between the scaling window size of the current picture and the scaling window size of the reference picture is within the ratio constraint [⅛, 2]. Two times the scaling window width of the current picture is greater than or equal to the scaling window width of the reference picture, two times the scaling window height of the current picture is greater than or equal to the scaling window height of the reference picture, the scaling window width of the current picture is less than or equal to eight times the scaling window width of the reference picture, and the scaling window height of the current picture is less than or equal to eight times the scaling window height of the reference picture. That is, PicOutputWidthL*2≥refPicOutputWidthL, PicOutputHeightL*2≥refPicOutputHeightL, PicOutputWidthL≤refPicOutputWidthL*8, and PicOutputHeightL≤refPicOutputHeightL*8.

To generalize the above embodiment of constraining the scaling window width and scaling window height of the current picture based on the scaling window width and scaling window height of the reference picture, it is a requirement of the bitstream conformance that all of the following conditions are satisfied. N times the scaling window width of the current picture is greater than or equal to the scaling window width of the reference picture, N times the scaling window height of the current picture is greater than or equal to the scaling window height of the reference picture, the scaling window width of the current picture is less than or equal to M times the scaling window width of the reference picture, and the scaling window height of the current picture is less than or equal to M times the scaling window height of the reference picture. The ratio between the scaling window size of the current picture and the scaling window size of the reference picture is between a ratio constraint [1/M, N], where N and M are positive integers, for example, N is 2 and M is 8 in the previous embodiment. PicOutputWidthL*N≥refPicOutputWidthL, PicOutputHeight*N≥refPicOutputHeight, PicOutputWidthL≤refPicOutputWidthL*M, and PicOutputHeightL≤refPicOutputHeightL*M.

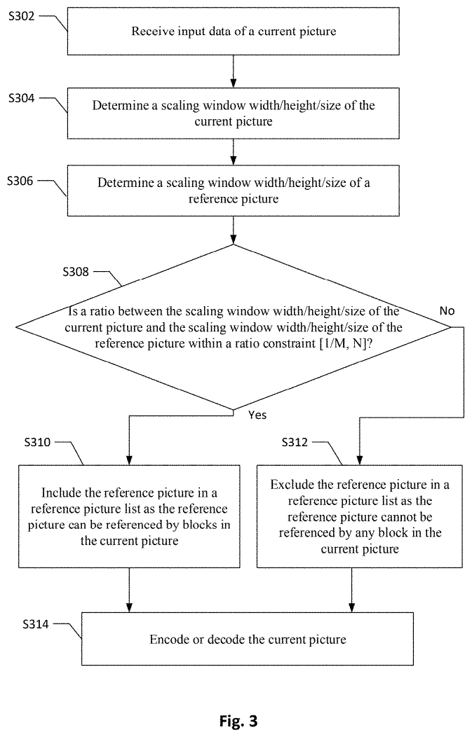

In one embodiment, a ratio constraint [1/M, N] is determined, to encode or decode a current picture, an encoder or decoder checks if one or more reference pictures satisfied the ratio constraint by determining a scaling window width, height, or size of the current picture and a scaling window width, height, or size of the reference picture. Only the reference picture with a scaling window width, height, or size satisfying the ratio constraint can be referenced by the current picture. FIG. 3 is a flowchart illustrating an example of this embodiment.

In some other embodiments, a ratio constraint [1/M, N] is determined, and an encoder or decoder determines a scaling window width, height, or size of a current picture according to a scaling window width, height, or size of a reference picture in order to satisfy the ratio constraint. In one embodiment, the same ratio constraint may constrain both the scaling window ratio and the picture size ratio, and the encoder or decoder also determines a picture size of the current picture according to a picture size of the reference picture to follow the ratio constraint.

In another embodiment, scaling window offsets signaled in the PPS are measured in chroma samples, a scaling window width of a current picture PicOutputWidthL is derived by a picture width pic_width_in_luma_samples, a left scaling window offset scaling_win_left_offset, and a right scaling window offset scaling_win_right_offset signaled in the PPS, as well as a variable SubWidthC. The value of the variable SubWidthC is defined according to the color sampling format of the video data; for example, SubWidthC is equal to 2 when the color sampling format is 4:2:0. PicOutputWidthL=pic_width_in_luma_samples−SubWidthC*(scaling_win_right_offset+scaling_win_left_offset). Similarly, a scaling window height of the current picture PicOutputHeightL is derived by a picture height pic_height_in_luma_samples, a top scaling window offset scaling_win_top_offset, and a bottom scaling window offset scaling_win_bottom_offset, as well as a variable SubHeightC. The value of the variable SubHeightC is also defined according to the color sampling format of the video data. SubHeightC is equal to 2 when the color sampling format is 4:2:0. PicOutputHeightL=pic_height_in_luma_samples−SubHeightC*(scaling_win_bottom_offset+scaling_win_top_offset). The variables SubWidthC and SubHeightC indicate down-sampling ratios associated with the chroma bitplanes in horizontal and vertical dimensions respectively.

Let refPicOutputWidthL and refPicOutputHeightL be a scaling window width and a scaling window height of a reference picture referenced by a current block of the current picture, where refPicOutputWidthL and refPicOutputHeightL are derived by the picture width and height, scaling window offsets, and the variable SubWidthC and SubHeightC. It is a requirement of the bitstream conformance that all of the following four conditions are satisfied. Two times the scaling window width of the current picture is greater than or equal to the scaling window width of the reference picture, two times the scaling window height of the current picture is greater than or equal to the scaling window height of the reference picture, the scaling window width of the current picture is less than or equal to eight times the scaling window width of the reference picture, and the scaling window height of the current picture is less than or equal to eight times the scaling window height of the reference picture. PicOutputWidthL*2≥refPicOutputWidthL, PicOutputHeightL*2≥refPicOutputHeightL, PicOutputWidthL≤refPicOutputWidthL*8, PicOutputHeightL≤refPicOutputHeightL*8.

A reference picture scaling ratio, RefPicScale[i][j][0], RefPicScale[i][j][1], is derived for motion compensation from the scaling window size, width, or height specified in the PPS. The reference picture scaling ratio affects which filters are used in the motion compensation stage, and it also affects the memory bandwidth used for the motion compensation stage. In addition to constrain the picture size ratio, embodiments of the present invention constrain the reference picture scaling ratio as well. For example, the reference picture scaling ratio RefPicScale[i][j][0] and RefPicScale[i][j][1] shall be constrained to be within the range of [2048, 32768], which is equivalent to a scaling ratio of [⅛, 2]. It is a requirement of the bitstream conformance that all of the following conditions are satisfied: RefPicScale[i][j][0] shall be greater than or equal to 2048, and shall be smaller than or equal to 32768, and RefPicScale[i][j][1] shall be greater than or equal to 2048, and shall be smaller than or equal to 32768.

For example, three different interpolation filter sets can be selected in motion compensation depending on the scaling ratio. A first interpolation filter set (set 0) includes a 8-tap DCT-IF filter, an affine 6-tap DCT-IF filter, and a 6-tap Half pixel IF filter, and a second interpolation filter set (set 1) includes 8-tap RPR filters and corresponding 6-tap affine filters for 1.5× ratio, and a third interpolation filter set (set 2) includes 8-tap RPR filters and corresponding 6-tap affine filters for 2.0× ratio. For processing a current block associated with a scaling ratio between ⅛ and 1.25, filters in set 0 are selected, for processing a current block associated with a scaling ratio between 1.25 and 1.75, filters in set 1 are selected, and for processing a current block associated with a scaling ratio between 1.75 and 2, filters in set 2 are selected.

Exemplary Flowchart for FIG. 3 illustrates an exemplary flowchart of a video encoding or decoding system for checking a scaling ratio between a current picture and a reference picture according to an embodiment of the present invention. The video encoding or decoding system receives input data associated with a current picture in step S302, and determines a scaling window width, height, or size of the current picture in step S304. For example, the scaling window size includes both the scaling window width and scaling window height. In this embodiment, the scaling window width of the current picture is derived by a picture width, a left scaling window offset, and a right scaling window offset of the current picture, and the scaling window height of the current picture is derived by a picture height, a top scaling window offset, and a bottom scaling window offset of the current picture. Syntax elements associated with these scaling window offsets and the picture width and height are signaled in a PPS corresponding to the current picture. In step S306, a scaling window width, height, or size of a reference picture is determined. Similarly, the scaling window width of the reference picture is derived by a picture width, a left scaling window offset, and a right scaling window offset of the reference picture, and the scaling window height of the reference picture is derived by a picture height, a top scaling window offset, and a bottom scaling window offset of the reference picture. Syntax elements associated with these scaling window offsets and the picture width and height of the reference picture are signaled in a PPS corresponding to the reference picture. The video encoding or decoding system checks if a ratio between the scaling window width, height, or size of the current picture and the scaling window width, height, or size of the reference picture is within a ratio constraint [1/M, N] in step S308. For example, the ratio constraint is [⅛, 2], which means 2 times the scaling window width/height of the current picture is greater than or equal to the scaling window width/height of the reference picture, and the scaling window width/height of the current picture is less than or equal to 8 times the scaling window width/height of the reference picture. The reference picture is included in a reference picture list for one or more blocks in the current picture in step S310 when the ratio is within the ratio constraint, so that the reference picture can be referenced by the blocks in the current picture. In step S312, in cases when the ratio is not within the ratio constraint, the reference picture is excluded in a reference picture list as the reference picture cannot be referenced by any block in the current picture. The video encoding or decoding system further encodes or decodes the current picture in step S314.

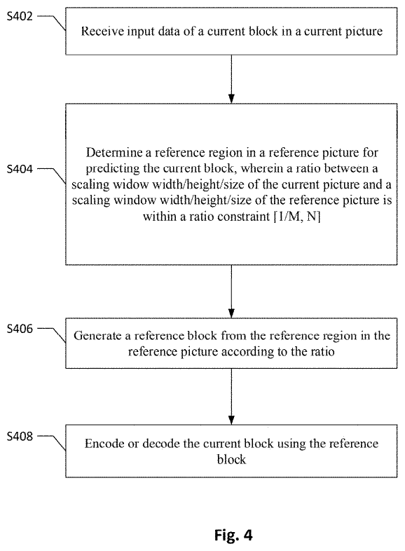

FIG. 4 illustrates an exemplary flowchart of a video encoding or decoding system for encoding or decoding a current block by enabling reference picture resampling according to an embodiment of the present invention. The video encoding or decoding system receives input video data of a current block in a current picture in step S402. In step S404, a reference region in a reference picture is determined for prediction or motion compensation of the current block. A ratio between a scaling window width, height, or size of the current picture and a scaling window width, height, or size of the reference picture is within a ratio constraint [1/M, N]. The video encoding or decoding system generates a reference block from the reference region in the reference picture according to the ratio in step S406, and encodes or decodes the current block using the reference block in step S408.

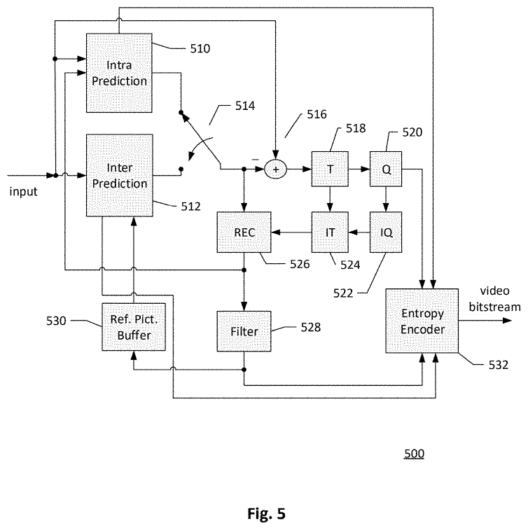

Video Encoder and Decoder Implementations The foregoing proposed video processing methods for reference picture resampling can be implemented in video encoders or decoders. For example, a proposed video processing method is implemented in an inter prediction module of an encoder, and/or an inter prediction module of a decoder. Alternatively, any of the proposed methods is implemented as a circuit coupled to one or a combination of the inter prediction module and/or one or a combination of the inter prediction module of the decoder, so as to provide the information needed by the inter prediction module. FIG. 5 illustrates an exemplary system block diagram for a Video Encoder 500 implementing various embodiments of the present invention. An Intra Prediction module 510 provides intra predictors based on reconstructed video data of a current picture. An Inter Prediction module 512 performs motion estimation (ME) and MC to provide inter predictors based on video data from other picture or pictures. To encode a current block in a current picture according to some embodiments of the present invention, a reference region in a valid reference picture is determined, and a scaling ratio between the current picture and any valid reference picture is within a ratio constraint [1/M, N]. The reference block is generated from the reference region and is used for motion compensation of the current block. The ratio constraint is defined according to interpolation filters for motion compensation, for example, the ratio constraint is between ⅛ and 2. In another embodiment, the Intra Prediction module 510 determines a scaling window width, height, or size of the current picture according to the ratio constraint and the scaling window width, height, or size of one or more reference picture for the current picture. A switch 541 selects either the Intra Prediction module 510 or Inter Prediction 512 to supply the selected predictor to an Adder 516 to form prediction errors, also called prediction residual. The prediction residual of the current block are further processed by a Transformation module (T) 518 followed by a Quantization module (Q) 520. The transformed and quantized residual signal is then encoded by an Entropy Encoder 532 to form a video bitstream. The video bitstream is then packed with side information. The transformed and quantized residual signal of the current block is then processed by an Inverse Quantization module (IQ) 522 and an Inverse Transformation module (IT) 524 to recover the prediction residual. As shown in FIG. 5, the prediction residual is recovered by adding back to the selected predictor at a Reconstruction module (REC) 526 to produce reconstructed video data. The reconstructed video data may be stored in a Reference Picture Buffer (Ref. Pict. Buffer) 530 and used for prediction of other pictures. The reconstructed video data recovered from the REC module 526 may be subject to various impairments due to encoding processing; consequently, an In-loop Processing Filter 528 is applied to the reconstructed video data before storing in the Reference Picture Buffer 530 to further enhance picture quality.

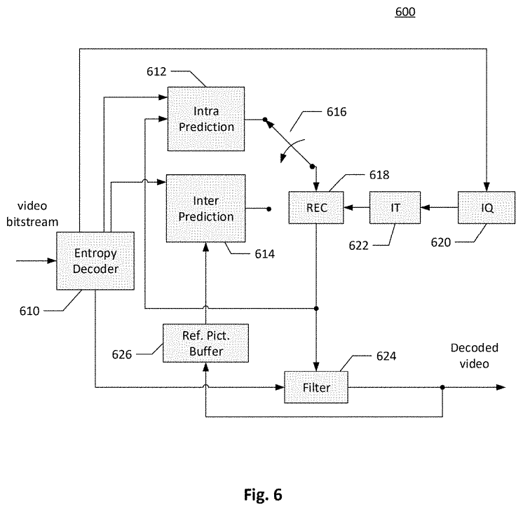

A corresponding Video Decoder 600 for decoding the video bitstream generated from the Video Encoder 500 of FIG. 5 is shown in FIG. 6. The video bitstream is the input to the Video Decoder 600 and is decoded by an Entropy Decoder 610 to parse and recover the transformed and quantized residual signal and other system information. The decoding process of the Decoder 600 is similar to the reconstruction loop at the Encoder 500, except the Decoder 600 only requires motion compensation prediction in an Inter Prediction 614. Each block is decoded by either an Intra Prediction module 612 or Inter Prediction module 614. To decode a current block in a current picture according to some embodiments of the present invention, the Inter Prediction module 614 determines a reference region in a reference picture. A ratio between a scaling window width, height, or size of the current picture and a scaling window width, height, or size of the reference picture is within a ratio constraint [1/M, N]. A reference block is then generated from the reference region based on the ratio, and the reference block is used for motion compensation of the current block in the Inter Prediction module 614. A Switch 616 selects an intra predictor from the Intra Prediction module 612 or an inter predictor from the Inter Prediction module 614 according to decoded mode information. The transformed and quantized residual signal associated with each block is recovered by an Inverse Quantization module (IQ) 620 and an Inverse Transformation module (IT) 622. The recovered residual signal is reconstructed by adding back the predictor in a REC module 618 to produce reconstructed video. The reconstructed video is further processed by an In-loop Processing Filter (Filter) 624 to generate final decoded video. If the currently decoded picture is a reference picture for later pictures in decoding order, the reconstructed video of the currently decoded picture is also stored in the Ref. Pict. Buffer 626.

Various components of Video Encoder 500 and Video Decoder 600 in FIG. 5 and FIG. 6 may be implemented by hardware components, one or more processors configured to execute program instructions stored in a memory, or a combination of hardware and processor. For example, a processor executes program instructions to control receiving of input data associated with a current picture. The processor is equipped with a single or multiple processing cores. In some examples, the processor executes program instructions to perform functions in some components in Encoder 500 and Decoder 600, and the memory electrically coupled with the processor is used to store the program instructions, information corresponding to the reconstructed images of blocks, and/or intermediate data during the encoding or decoding process. The memory in some embodiments includes a non-transitory computer readable medium, such as a semiconductor or solid-state memory, a random access memory (RAM), a read-only memory (ROM), a hard disk, an optical disk, or other suitable storage medium. The memory may also be a combination of two or more of the non-transitory computer readable mediums listed above. As shown in FIGS. 5 and 6, Encoder 500 and Decoder 600 may be implemented in the same electronic device, so various functional components of Encoder 500 and Decoder 600 may be shared or reused if implemented in the same electronic device.

Embodiments of the video processing method for encoding or decoding may be implemented in a circuit integrated into a video compression chip or program codes integrated into video compression software to perform the processing described above. For examples, determining a reference block in a reference picture may be realized in program codes to be executed on a computer processor, a Digital Signal Processor (DSP), a microprocessor, or field programmable gate array (FPGA). These processors can be configured to perform particular tasks according to the invention, by executing machine-readable software codes or firmware codes that defines the particular methods embodied by the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A video processing method in a video encoding or decoding system, comprising:
receiving input video data of a current block in a current picture;
determining a scaling window width, height, or size of the current picture;
determining a scaling window width, height, or size of a reference picture, wherein a ratio between the scaling window width, height, or size of the current picture and the scaling window width, height, or size of the reference picture is within a ratio constraint;
generating a reference block from the reference picture according to the ratio between the scaling window width, height, or size of the current picture and the scaling window width, height, or size of the reference picture;
performing motion compensation for the current block using the reference block; and
encoding or decoding the current block in the current picture.

2. The method of claim 1, wherein the ratio constraint is between ⅛ and 2.

3. The method of claim 2, wherein the scaling window size comprises both the scaling window width and the scaling window height, and the ratio between the scaling window size of the current picture and the scaling window size of the reference picture is within the ratio constraint when 2 times the scaling window width of the current picture is greater than or equal to the scaling window width of the reference picture, 2 times the scaling window height of the current picture is greater than or equal to the scaling window height of the reference picture, the scaling window width of the current picture is less than or equal to 8 times the scaling window width of the reference picture, and the scaling window height of the current picture is less than or equal to 8 times the scaling window height of the reference picture.

4. The method of claim 1, wherein the scaling window width of the current picture is derived by a picture width, a left scaling window offset, and a right scaling window offset of the current picture, and the scaling window height of the current picture is derived by a picture height, a top scaling window offset, and a bottom scaling window offset of the current picture.

5. The method of claim 4, wherein the scaling window width of the current picture is derived by subtracting the left scaling window offset and the right scaling window offset from the picture width of the current picture, and the scaling window height of the current picture is derived by subtracting the top scaling window offset and the bottom scaling window offset from the picture height of the current picture.

6. The method of claim 4, wherein the picture width, left scaling window offset, right scaling window offset, picture height, top scaling window offset, and bottom scaling window offset of the current picture are signaled in a Picture Parameter Set (PPS) associated with the current picture.

7. The method of claim 4, wherein the left scaling window offset, right scaling window offset, top scaling window offset, and bottom scaling window offset are measured in chroma samples.

8. The method of claim 7, wherein the scaling window width of the current picture is further derived by a variable SubWidthC and the scaling window height of the current picture is further derived by a variable SubHeightC, wherein the variables SubWidthC and SubHeightC indicate down-sampling ratios associated with chroma bitplanes in horizontal and vertical dimensions.

9. The method of claim 8, wherein the scaling window width of the current picture is derived by multiplying the variable SubWidthC with a sum of the left scaling window offset and the right scaling window offset and then subtracting from the picture width of the current picture, and the scaling window height of the current picture is derived by multiplying the variable SubHeightC with a sum of the top scaling window offset and the bottom scaling window offset and then subtracting from the picture height of the current picture.

10. The method of claim 1, wherein the ratio constraint is between 1/M and N, wherein M and N are positive integers.

11. The method of claim 1, wherein the scaling window size comprises both the scaling window width and the scaling window height, and the ratio between the scaling window size of the current picture and the scaling window size of the reference picture is within the ratio constraint when N times the scaling window width of the current picture is greater than or equal to the scaling window width of the reference picture, N times the scaling window height of the current picture is greater than or equal to the scaling window height of the reference picture, the scaling window width of the current picture is less than or equal to M times the scaling window width of the reference picture, and the scaling window height of the current picture is less than or equal to M times the scaling window height of the reference picture.

12. The method of claim 1, wherein a reference picture scaling ratio is derived for motion compensation from the scaling window width, height, or size of the current picture and the scaling window width, height, or size of the reference picture, and the reference picture scaling ratio is constrained to be within a range of [2048, 32768].

13. The method of claim 1, further comprising generating, at an encoder side, or receiving, at a decoder side, a bitstream corresponding to encoded data of a video sequence, wherein the bitstream complies with a bitstream conformance requirement that 2 times the scaling window width of the current picture is greater than or equal to the scaling window width of the reference picture, 2 times the scaling window height of the current picture is greater than or equal to the scaling window height of the reference picture, the scaling window width of the current picture is less than or equal to 8 times the scaling window width of the reference picture, and the scaling window height of the current picture is less than or equal to 8 times the scaling window height of the reference picture.

14. An apparatus of processing video data in a video encoding or decoding system, the apparatus comprising one or more electronic circuits configured for:
receiving input video data of a current block in a current picture;
determining a scaling window width, height, or size of the current picture;
determining a scaling window width, height, or size of a reference picture, wherein a ratio between the scaling window width, height, or size of the current picture and the scaling window width, height, or size of the reference picture is within a ratio constraint;
generating a reference block from the reference picture according to the ratio between the scaling window width, height, or size of the current picture and the scaling window width, height, or size of the reference picture;
performing motion compensation for the current block using the reference block; and
encoding or decoding the current block in the current picture.

15. A non-transitory computer readable medium storing program instruction causing a processing circuit of an apparatus to perform a video processing method for video data, and the method comprising:
receiving input video data of a current block in a current picture;
determining a scaling window width, height, or size of the current picture;
determining a scaling window width, height, or size of a reference picture, wherein a ratio between the scaling window width, height, or size of the current picture and the scaling window width, height, or size of the reference picture is within a ratio constraint;
generating a reference block from the reference picture according to the ratio between the scaling window width, height, or size of the current picture and the scaling window width, height, or size of the reference picture;
performing motion compensation for the current block using the reference block; and
encoding or decoding the current block in the current picture.
